(19) United States
(12) Patent Application Publication
(10) Pub. No.: US 2011/0314971 A1
(43) Pub. Date: Dec. 29, 2011

(54) ONE ARMED HAMMER AND SYSTEM

(76) Inventor: Matthew Nicosia, LaCenter, WA (US)

(21) Appl. No.: 12/970,814

(22) Filed: Dec. 16, 2010

Related U.S. Application Data
(60) Provisional application No. 61/287,113, filed on Dec. 16, 2009.

(51) Int. Cl. B25D 1/06; B25D 1/04

(52) U.S. Cl. 81/24; 81/23

(57) ABSTRACT

The hammer system of an embodiment may allow a user to start driving a nail (e.g., into a board or the like) without having to hold the nail with their other, non-hammering hand. For example, the hammer system may accept and detachably couple to a nail. Once coupled, the hammer system may partially drive the nail, for example with a moderate strike and/or multiple taps, such that the nail is substantially secure and/or stable enough to accept subsequent driving strikes without the user having to hold the nail in place.

### CROSS-REFERENCE TO RELATED APPLICATION

This application is a nonprovisional application claiming priority to co-pending provisional patent application Ser. No. 61/287,113, filed Dec. 16, 2009, which is incorporated herein by reference.

### FIELD OF THE INVENTION

The present invention relates to a hammer. More particularly, the present invention relates to a hammer and hammer system operable one arm to deploy and hammer nails.

### BACKGROUND

A hammer is a tool meant to deliver an impact to an object. The most common uses are for driving nails, fitting parts, forging metal and breaking up objects. Hammers are often designed for a specific purpose, and vary widely in their shape and structure. The usual features are a handle and a head, with most of the weight in the head. The basic design is hand-operated, but there are also many mechanically operated models for heavier uses.

One general type of hammer is a claw hammer. A claw hammer is a tool primarily used for pounding nails into, or extricating nails from, some other object. Generally, a claw hammer is associated with woodworking but is not limited to use with wood products. Claw hammers can be constructed many ways but generally come in one of two forms. The first, and most popular, type of hammer is the two piece hammer. This hammer is constructed from a forged steel head with a hole for fixing a handle. Wooden handles are (almost invariably) hickory. One end is made to fit the hole in the hammer head, and then a steel wedge is driven into the wood which forces it to expand and secure the hammer head to the handle. Other handle materials include glass fiber and even carbon fiber. Another type of claw hammer is single-piece forged heat-treated steel where the head and handle are integral. These hammers often have polymer grips to add to their ergonomics and decrease vibrations when the hammer is used.

A specific style of claw hammer is the framing hammer. This is an over-sized claw hammer used in framing carpentry. The larger and heavier head can decrease the number of blows required to fully insert the nail. Framing hammers commonly have a “checkered” face, which reduces skip-off of the head if the blow is not precisely struck on the nail. Framing hammers also have a much straighter claw than regular claw hammers, as the claw is designed more for prying nailed boards apart, rather than removing nails (though its claw can also be used in that capacity). Typically the head of a framing hammer will be made of steel and the handle of wood. Lightweight titanium heads with longer handles allow for increased velocity, resulting in greater energy delivery, while decreasing arm fatigue and risk of carpal tunnel syndrome.

For any of the hammer configurations described above, a carpenter must use two hands to at least get the nail started into the board, wood, or any other material. For example, a right-handed carpenter may hold a nail in place with their left hand and swing the hammer with their right hand until the nail is driven/embedded enough to provide stability for subsequent hammer blows. Not only does the use of a second hand slow the process, but it is also a safety concern. Amateur and professional carpenters alike have all likely experienced a bruised and/or crushed thumb and/or finger during their hammering endeavors.

### SUMMARY AND ADVANTAGES

The hammer and hammer system of an embodiment the present invention presents numerous advantages, including: (1) prevents injury by substantially eliminating the need to hold a nail while initially striking and driving it; (2) allows a rapid transition between starting a nail and driving a nail; (3) holds nails without fragile or complex mechanisms; (4) can be configured and/or adjusted for multiple nail sizes and/or ranges of size; (5) substantially inert to the elements; (6) substantially monolithic construction maintains its durability; (7) allows hammering with only one arm so that the other arm may be used for stability and/or other tasks; and (8) allows a physically disabled person or arm amputee to hammer with only one arm.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows the side view of a hammer of an embodiment.

FIG. 2 shows the side view of a nail cartridge of an embodiment.

FIG. 3 shows the top view of the nail cartridge of FIG. 2.

FIG. 4 shows the side view of a first side of a nail magazine of an embodiment.

FIG. 5 shows the side view of a second side of the nail magazine of an embodiment.

FIG. 6 shows the side view of the inside of the nail magazine of an embodiment.

FIG. 7 shows the side view of a third side of the nail magazine of an embodiment.

### REFERENCE NUMBERS USED IN DRAWINGS

Turning now descriptively to the drawings, in which similar reference characters denote similar elements throughout the several views, the figures illustrate the hammer system of an embodiment of the present invention. With regard to the reference numerals used, the following numbering is used throughout the various drawing figures:
10 hammer system
20 hammer head
22 striking surface
25 hammer body
30 funnel aperture
32 funnel sidewall
34 funnel back
36 gap
38 magnet
40 nail remover
50 shaft
55 handle
60 nail cartridge
61 nail aperture
62 nail
64 push up block groove
70 nail magazine
72 nail track
74 nail ejector system
76 nail ejector contact arm
77 nail ejector contact arm clamp
78 nail ejector lever
80 nail ejector arm
82 nail ejector backplate
84 nail ejector spring
90 push up block knob
92 push up block knob track
93 push up block knob catch
94 push up block spring
96 push up block
98 push up block spring box

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

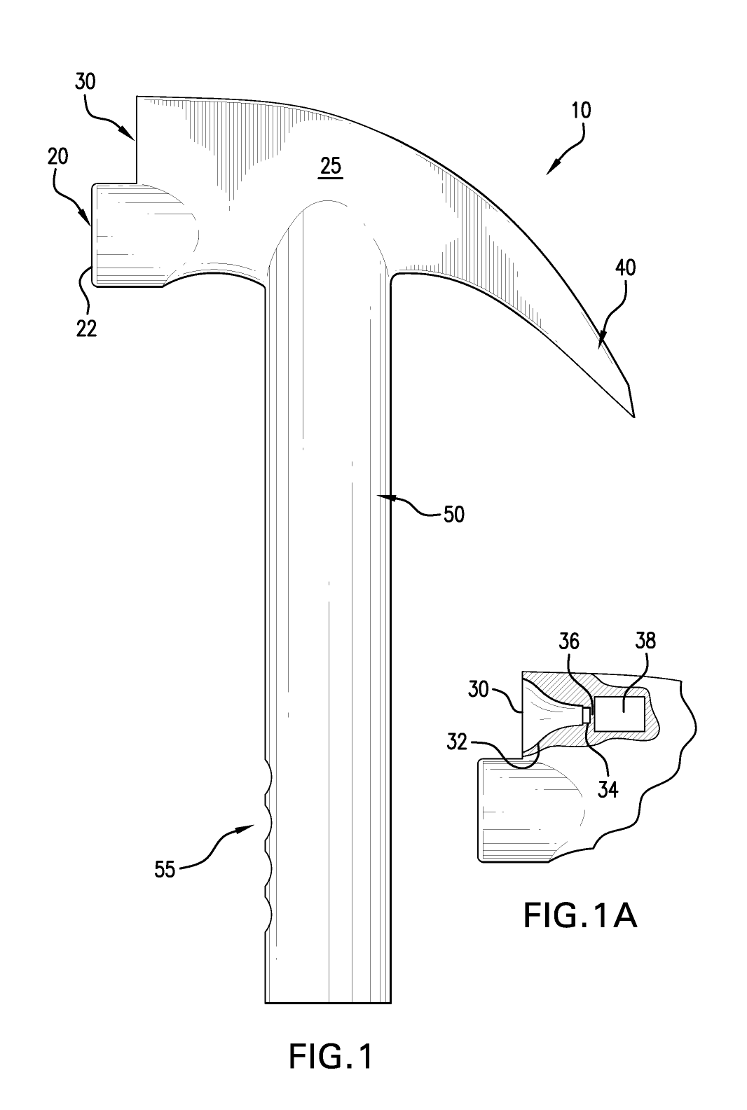

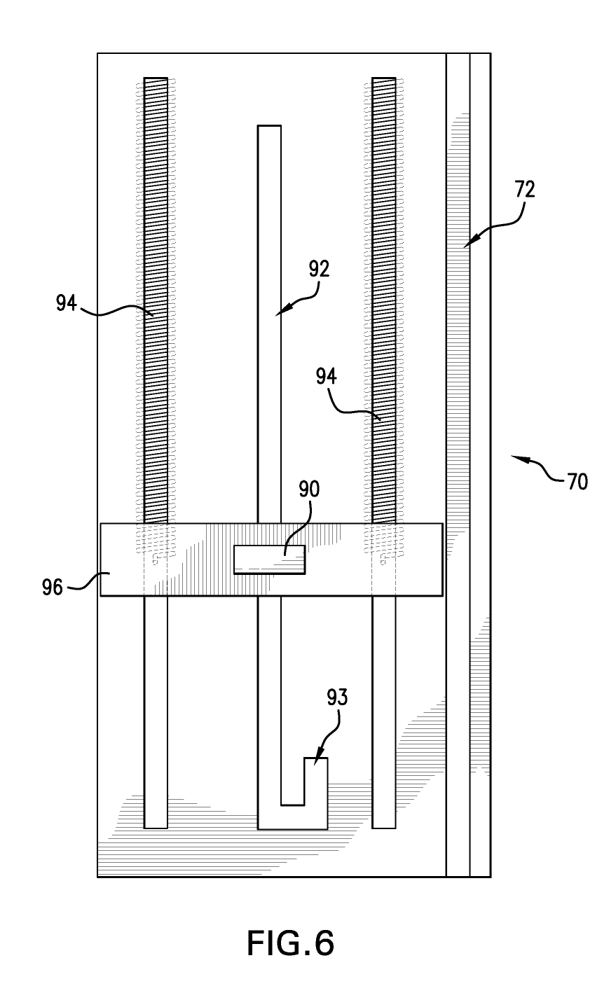

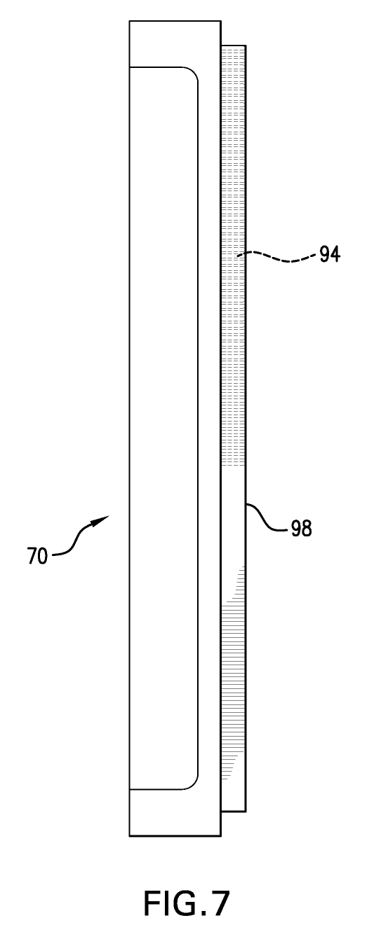

As shown in FIGS. 1-7, a hammer system 10 including a nail clip 70 containing nail clip 60 is provided. As shown in FIG. 1, hammer system 10 comprises a hammer head 20 including a striking surface 22, a hammer body 25, a nail remover 40, a shaft 50, and a handle 55. In an embodiment, the hammer system 10 may be approximately configured as and may function substantially similarly to a carpenter's hammer. More specifically, the hammer system 10 may be approximately configured as and may function substantially similarly to a carpenter's claw hammer. For example, a user may grasp the hammer system at handle 55 to swing the hammer head 20 coupled to and/or integrally formed with the shaft 50 to strike and drive a nail with striking surface 22. Errant nails may be removed by prying the nails with the nail remover 40 that may be approximately configured as and may function substantially similarly to a hammer claw. In an embodiment, at least the hammer head 20 including striking surface 22, the hammer body 25, and the nail remover 40 may be integrally formed.

Simply stated, the hammer system 10 of an embodiment may allow a user to start driving a nail (e.g., into a board or the like) without having to hold the nail with their other, non-hammering hand. For example, the hammer system 10 may accept and detachably couple to a nail. Once coupled, the hammer system 10 may partially drive the nail, for example with a moderate strike and/or multiple taps, such that the nail is substantially secure and/or stable enough to accept subsequent driving strikes without the user having to hold the nail in place. Accordingly, the hammer system 10 of an embodiment, in particular if deployed with the nail cartridge 60 and nail magazine 70, may increase the speed with which a user may start and drive nails while decreasing the possibility of injuring their non-hammering hand.

In an embodiment, the components of the hammer system 10 may be formed from materials common to the construction of carpenter's claw hammers. For example, the hammer system 10 may be formed as a two piece hammer for which the hammer head 20 including striking surface 22, hammer body 25, and nail remover 40 may be integrally formed from forged steel or other sufficiently durable and dense metal. The hammer body 25 may include an aperture and/or hole in which the shaft 50 may be inserted and fixed. In an embodiment, the shaft 50 may be formed from wood and in particular from a hard wood like hickory, glass fiber, or carbon fiber. In an alternate embodiment, at least the hammer head 20 including striking surface 22, hammer body 25, the nail remover 40, and the shaft 50 of the hammer system 10 may be integrally formed from a single piece of forged heat-treated steel or other sufficiently durable and dense metal. An integrally formed hammer system 10 may include a handle 55 formed from a polymer and/or other elastomeric material to contribute to the ergonomics of the hammer system 10 and to decrease vibrations when the hammer system 10 is used. For either embodiment, the striking surface 22 may include a texture, for example checkering, to mitigate skipping off nail heads when striking them.

As further illustrated by FIG. 1, the hammer system 10 may include funnel aperture 30 adjacent to the hammer head 20. In an embodiment, the funnel aperture 30 may be formed in the hammer body 25 and located above the hammer head 20 (i.e., distally from the hammer head 20 with respect to the shaft 50 and handle 55). In an embodiment, the funnel aperture 30 may be offset by slight distance (e.g., approximately 0.25 inch) from the striking surface 22. More specifically, the funnel aperture 30 may be offset by a slight distance toward the shaft 50 and nail remover 40 side of the hammer system 10. Accordingly, if the striking surface 22 were to contact a flat surface, the funnel aperture 30 would not also contact the surface.

The funnel aperture 30 of an embodiment may have a substantially circular shape. In an embodiment, the funnel aperture 30 may have a substantially circular shape with a diameter of approximately 1.25 inches. From the funnel aperture 30, the funnel sidewall 32 may constrict toward the funnel back 34. Like the funnel aperture 30, the funnel back 34 may have a substantially circular shape. In an embodiment, the funnel back 34 may have a diameter of approximately 7116, or 0.4375 inch to accommodate the head of a nail as will be described more in detail in the following paragraphs. Both the diameter of the funnel aperture 30 and the diameter of the funnel back 34 may correspond to a particular nail size or range of nail sizes. For example, the hammer system 10 of an embodiment may be configured to accept a 16-penny nail common to house framing and general carpentry.

In an embodiment, the taper of the funnel sidewall 32 may be substantially linear. For example, the funnel sidewall 32 may taper substantially linearly from the approximately 1.25 inch diameter funnel aperture 30 to the approximately 7/16, or 0.4375 inch diameter funnel back 34 over the distance of approximately 1.5 inches. Accordingly, the funnel aperture 30, funnel sidewall 32, and funnel back 34 may approximately define a conical frustum. In an alternate embodiment, the funnel side all 32 may taper more steeply adjacent the funnel aperture 30 and less steeply adjacent the funnel back 34. For example, the funnel sidewall 32 may taper at approximately 45 degrees relative to the centerline of the funnel aperture 30 for the first approximately 0.75 inch of the funnel sidewall 32, and less steeply over the next approximately 0.75 inch to the funnel back 34. The taper of the funnel sidewall 32 may be smooth or it may include multiple linear and/or smooth segments. The embodiments are not limited in this context.

The funnel back 34 of an embodiment is configured to accept a nail head (not illustrated) and to detachably couple to the nail head. More specifically, the hammer system 10 of an embodiment may include a magnet 38 adjacent the funnel back 34 to magnetically detachably couple to the nail head. The funnel back 34 may be separated from the magnet 38 by a gap 36. In an embodiment, the gap 36 may be approximately ⅛, or 0.125 inch thick. In an alternate embodiment, the gap 36 may be more than or less than approximately ⅛, or 0.125 inch thick. The magnet 38 of an embodiment may be an alnico magnet or rare earth magnet, for example a neodymium or a samarium-cobalt magnet. In an embodiment, magnet 38 is a neodymium-iron-boron magnet.

In an embodiment, the funnel back 34 and/or the gap 36 may allow a nail detachably coupled thereto to be struck by the funnel back 34 substantially without impacting and/or damaging the magnet 38. For example, a neodymium-iron-boron magnet 38 may be susceptible to damage if the nail head strikes it directly. The gap 36 may further mitigate and/or adjust the magnitude of the magnetic field experienced by the nail head to adjust the coupling force between the funnel back 34 and the nail head. For example, the nail head should couple to the funnel back 34 with substantially enough force to hold the nail in place as a user swings the hammer system 10 for the first swing to start the nail. However, once the nail is started, the funnel back 34 should release the nail substantially without withdrawing or otherwise disturbing the nail. Further, the funnel back 34 should release the nail without substantially interfering with the timing and effort of the hammer system 10 backswing for the following strike (e.g., with the striking surface 22 of hammer head 20) to drive the nail.

As noted, both the diameter of the funnel aperture 30 and the diameter of the funnel back 34 may correspond to a particular nail size or range of nail sizes. So too may the thickness of the gap 36 and/or the strength of the magnet 38. Though not illustrated, one or more of the funnel aperture 30, funnel sidewall 32, funnel back 34, gap 36, or the magnet 38 may be adjustable, interchangeable, or otherwise configurable for additional nail sizes and/or nail configurations. In particular, instead of formed in hammer body 25, the funnel aperture 30, funnel sidewall 32, funnel back 34, gap 36, and the magnet 38 may all be included in an interchangeable module specific to a nail size and/or an approximate range of nail sizes. The interchangeable module may removably couple to the hammer body 25 and/or hammer head 20 by any detachable mechanical means or engagement mechanisms, for example with one or more threaded connections, bolts, nuts, screws, latches, clasps, dovetails, and or a combination thereof. Alternately, at least the funnel aperture 30, funnel sidewall 32, and funnel back 34 may be interchangeable, for example with a threaded connection. Accordingly, in an embodiment, the hammer system 10 may configure, adjust, interchange, or the like to accommodate multiple nail sizes and/or ranges of nail sizes.

Further, though described with reference to magnet 38 detachably engaging a nail, the hammer system 10 of an embodiment may include alternate detachable engagement means to hold the nail in place for its initial strike. For example, non-ferromagnetic nails will not removably couple to the magnet 38. In an embodiment, the funnel sidewall 32 may frictionally or mechanically detachably engage a nail inserted through the funnel aperture 30. In either case, the funnel aperture 30, funnel sidewall 32, and/or funnel back 34 may detachably engage the nail with substantially enough force to hold the nail in place during the hammer system 10 initial backswing and forward swing while simultaneously releasing the nail without substantially interfering with the timing and effort of the hammer system 10 backswing for the following strike (e.g., with the striking surface 22 of hammer head 20) to drive the nail.

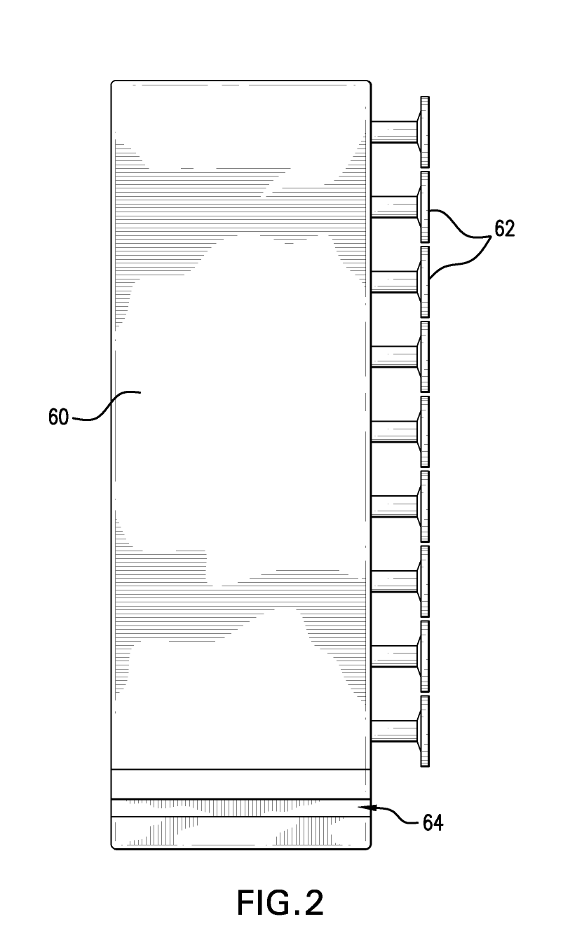

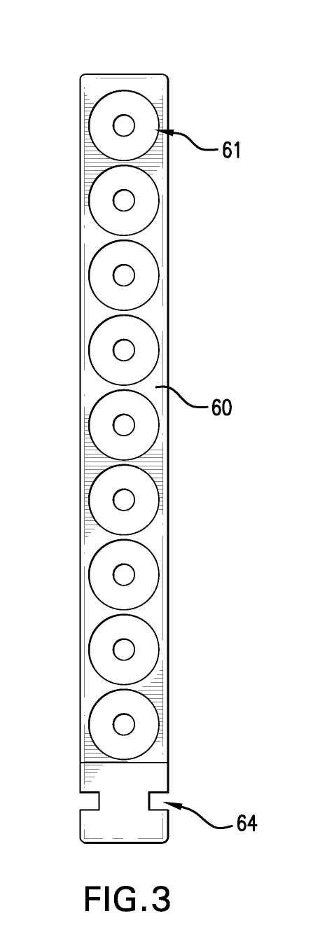

FIGS. 2 and 3 illustrate the nail cartridge 60 of an embodiment to deploy with nail magazine 70 to increase the speed with which a user may start and drive nails with the hammer system 10. The nail cartridge 60 may operate with nail magazine 70 similar to a firearm magazine to conveniently deploy nails substantially directly to the funnel aperture 30, funnel sidewall 32, and/or funnel back 34 of hammer system 10 to be releasably held in place to initially strike the nail.

More specifically, the nail cartridge 60 may be a disposable nail cartridge 60 formed from heavy paper or card stock, cardboard, corrugated cardboard, a combination thereof, or the like. Each nail, in an embodiment a 16 penny nail, may occupy a nail aperture 61 formed in the nail cartridge. In an embodiment, nails may frictionally detachably couple to the nail apertures 61 so that they substantially remain in the nail cartridge 60 until ejected by the nail magazine 70. In an embodiment, the nail apertures 61 are arranged in a linear pattern such that the nail cartridge 60 may operate with nail magazine 70 similar to a single-stack firearm magazine. Alternately, the nail apertures 61 may be staggered or otherwise two-dimensionally patterned to more densely arrange the nails in the nail cartridge 60, for example for a high capacity nail cartridge 60. An end of the nail cartridge 60 may include a push up block groove 64 to detachably engage and/or interoperate with the push up block 96 as will be described more with reference to nail magazine 70.

In an embodiment, the nail magazine 70 may adjust to accommodate multiple sizes or ranges of sizes of the nail cartridge 60. In alternate embodiment, the nail magazine 70 may accommodate a substantially fixed size of the nail cartridge 60. In that embodiment, a nail cartridge 60 that is smaller than the fixed size may be accompanied by a nail cartridge spacer (not illustrated). For example, the nail cartridge 60 including short nails may be short itself. Accordingly, to fit in and properly interoperate with the nail magazine 70, the nail cartridge 60 may be accompanied by a nail cartridge spacer (not illustrated) adjacent the side of the nail cartridge 60 having the points of the multiple nails contained therein. In such a manner, the nail magazine 70 may be compatible with multiple nail sizes as represented by multiple nail cartridge 60 sizes. Further, the nail cartridge spacer may be re-useable.

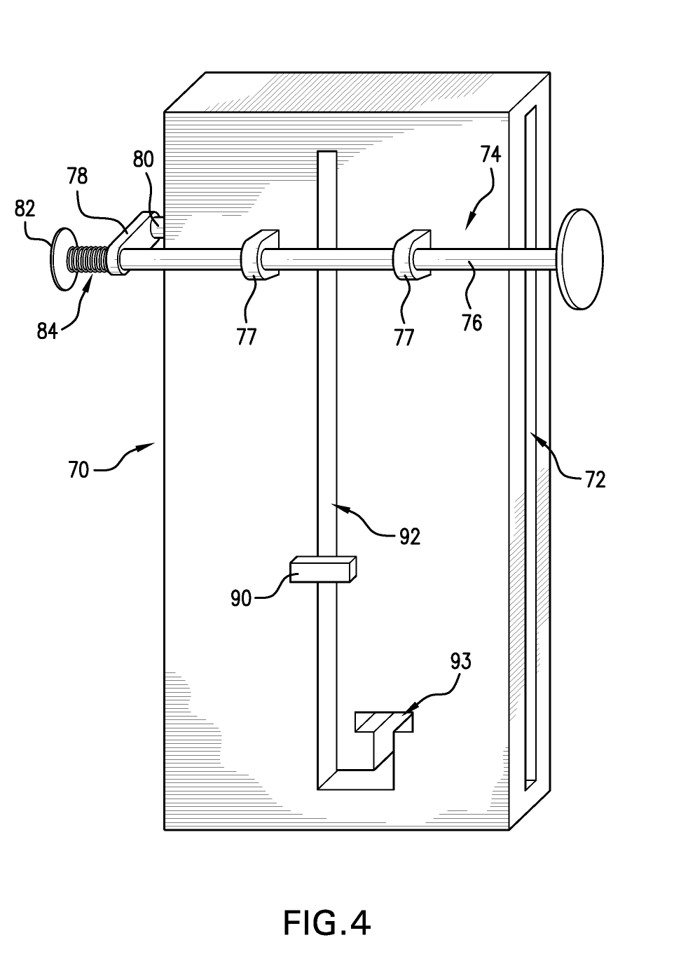

FIGS. 4-7 illustrate the nail magazine 70 of an embodiment to accept nail cartridges 60 and to eject nails substantially directly to the hammer system 10. For example, a user may strike the nail ejector system 74 with the striking surface 22 of the hammer system 10 to eject a nail. If the nail magazine 70 and the hammer system 10 are properly oriented, the nail magazine will eject a nail substantially directly into the funnel aperture 30, funnel sidewall 32, and/or funnel back 34 of hammer system 10 to be releasably held in place (e.g., by magnet 38) to initially strike the nail. Once a nail has been ejected into the hammer system 10 and withdrawn from the nail cartridge 60, the nail magazine 70 may advance to the next nail in the nail cartridge. Accordingly, the nail magazine 70 including nail cartridge 60 may substantially rapidly deploy nails to the hammer system 10.

More specifically, nail magazine 70 may include a nail track 72 out of which the nails from the nail cartridge 60 may extend and/or eject. The nail ejector system 74 may further include a nail ejector contact arm 76 coupled to the nail magazine 70 with one or more nail ejector contact arm clamps 77 in which the nail ejector contact arm 76 may slide. The nail ejector contact arm 76 may couple to and actuate a nail ejector lever 78. In an embodiment, the nail ejector lever 78 may be biased by nail ejector spring 84 coupled to nail ejector backplate 82. The nail ejector lever 78 may in turn couple to and actuate the nail ejector arm 80 to eject nails from the nail cartridge 60 included within the nail magazine. Further, though described as semi-automatic, the nail magazine 70 of an embodiment may alternately operate substantially automatically to eject nails to a distance from which the nails may detachably engage funnel aperture 30, funnel sidewall 32, and/or funnel back 34 of hammer system 10 to be releasably held in place (e.g., by magnet 38) to initially strike the nail. The withdrawal of one nail may trigger the nail magazine 70 to advance to the next nail in the nail cartridge 60.

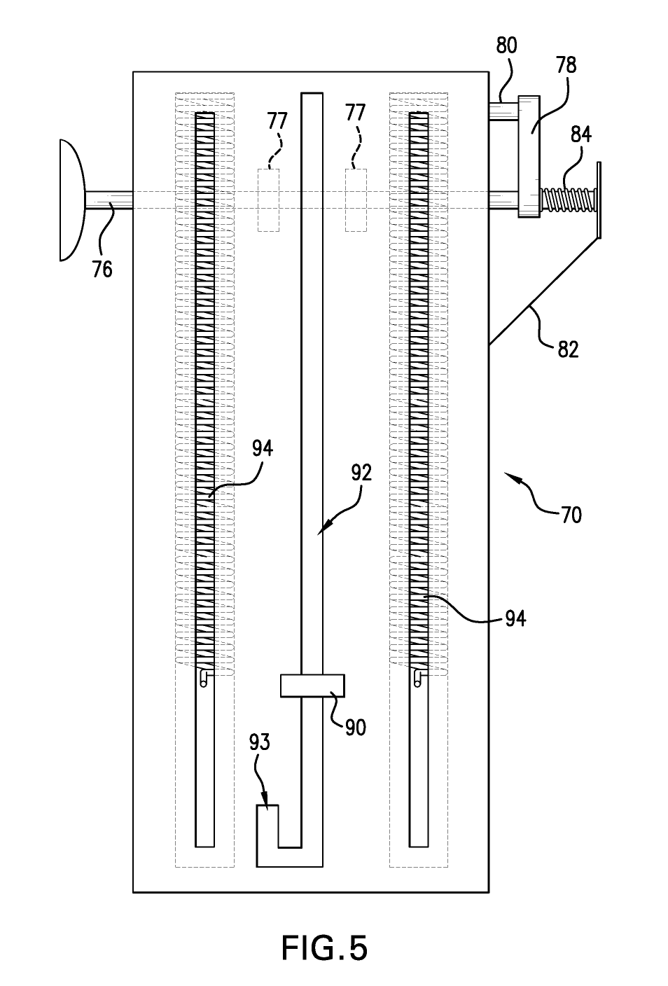

Within the nail magazine 70, the nail cartridge 60 may couple to a push up block 96. In particular, the push up block 96 may detachably engage one or more push up block grooves 64 formed in the nail cartridge 60. The push up block 96 may further include a push up block knob 90 coupled thereto. The push up block knob 90 may slide within the push up block knob track 92 to laterally translate the push up block 96 within the nail magazine. As further illustrated by FIGS. 5-7, the push up block 96 may be biased by one or more push up block springs 94 contained in and/or guided by one or more corresponding push up block spring boxes 98. The spring bias of the push up block 96 pushes and/or advances the nail cartridge 60 as each nail is ejected. To facilitate loading a nail cartridge 60 within the nail magazine 70, the push up block knob track 92 may further include a push up block knob catch 93 to detachably engage the push up block knob 90 when the push up block springs 94 are compressed and/or extended to spring bias the push up block 96.

Though the push up block springs 94 are illustrated as two coil or helical springs operating in tension, an embodiment of the nail magazine 70 is not limited in this context. For example, the nail magazine 70 may further include one or more coil or helical springs operating in compression, or any other type of spring to bias the push up block 96 and nail cartridge 60 coupled thereto. In an embodiment, the one or more push up block springs 94 may bias the push up block 96 substantially throughout the push up block 96 travel. Accordingly, in an embodiment, a push up block spring 94 may be a flat coil spring so that the coils themselves occupy substantially minimal space as the flat coil spring is either substantially fully compressed or substantially without tensions (e.g., depending on the whether the flat coil spring operates in compression or tension).

In operation in one embodiment, a right-handed user may grasp the hammer system 10 in their right hand. They may additionally grasp the nail magazine 70 including a nail cartridge 60 in their left hand. Alternately, the nail magazine including a nail cartridge 60 may be attached to another portion of the user (e.g., left arm or belt), attached to another surface, or may be free standing. The user may then strike the nail ejector contact arm 76 with the striking surface 22 of the hammer system 10. By doing so, the user may actuate the nail ejector system 74 of an embodiment to eject a nail into the nail funnel aperture 30. In an embodiment, the nail ejector system 74 ejects the nail with sufficient distance so that the nail may detachably engage the funnel back 34, for example based on the nail's attraction to magnet 38 and as guided by funnel sidewall 32. Thereafter the user may withdraw the remaining nail from the nail magazine 70 including nail cartridge 60 (if any portion of the nail remains coupled thereto) and swing the hammer system 10 including the nail to strike and drive the nail with the initial hammer system 10 blow without holding the nail with their left hand. The user may then withdraw the hammer system 10, during which the nail may detach from the funnel back 34 and remain in the surface in which it had been driven. The user may follow up with one or more additional strikes with striking surface 22 to drive the nail to its desired depth. By this point, the nail magazine 70 including the nail cartridge 60 has advanced to another nail, so the user need only strike the nail ejector contact arm 76 again and/or repeatedly to deploy additional nails.

In an alternate embodiment, the nail magazine 70 of an embodiment may alternately operate substantially automatically to eject nails to a distance from which the nails may detachably engage funnel aperture 30, funnel sidewall 32, and/or funnel back 34 of hammer system 10 to be releasably held in place (e.g., by magnet 38) to initially strike the nail. Accordingly, as the withdrawal of one nail may trigger the nail magazine 70 to advance to the next nail in the nail cartridge 60, the user need not strike the nail ejector contact arm 76 with the striking surface 22 of the hammer system 10. They need only bring the hammer system 10 within a certain proximity to the nail magazine 70 to detachably engage a nail.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A hammer system, comprising:
a hammer body;
a striking surface integrally formed with the hammer body;
and a nail holding portion formed in the hammer body adjacent the striking surface.

2. The hammer system of claim 1, the nail holding portion further comprising:
a funnel aperture;
a funnel sidewall; and
a funnel back.

3. The hammer system of claim 2, the nail holding portion further comprising:
a magnet disposed within the hammer body adjacent the funnel back to magnetically attract a nail.

4. The hammer system of claim 3, the nail holding portion further comprising:
a gap formed in the hammer body and disposed between the funnel back and the magnet to substantially prevent the nail from imparting compressive force on the magnet.

5. The hammer system of claim 1 further comprising:
a nail magazine to eject one or more nails into the nail holding portion.

6. The hammer system of claim 5, the nail magazine to eject one or more nails into the nail holding portion in response to a hammer strike.
